(19) United States
(12) Patent Application Publication
(10) Pub. No.: US 2010/0049832 A1
(43) Pub. Date: Feb. 25, 2010

(54) COMPUTER PROGRAM PRODUCT, A SYSTEM AND A METHOD FOR PROVIDING VIDEO CONTENT TO A TARGET SYSTEM

(75) Inventors: Gal PELEG, Kiryat-Ono (IL); Ori Berman, Ramat-Hasharon (IL); Michael Sasson, Tel Aviv (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: COMVERSE LTD, Tel Aviv (IL)

(21) Appl. No.: 12/195,620

(22) Filed: Aug. 21, 2008

(51) Int. Cl. G06F 15/16

(52) U.S. Cl. 709/219

(57) ABSTRACT

A method for providing video content to a target system, the method including: acquiring multiple groups of frames from a stream of frames; processing each group of frames out of the multiple groups of frames to provide a video file; and transmitting the video file to the target system; wherein the acquiring, processing and transmitting partially overlap.

### FIELD OF THE INVENTION

The invention relates to computer program products, methods and systems for providing video content.

### BACKGROUND OF THE INVENTION

Transmission of video content to remote systems is in wide use today, for many different purposes and clients. Such solutions include, for example, streaming of video content to clients, transferring complete video files and the like.

Video content is conveniently either captured (e.g. by video cameras), produced by a media content provider (e.g. news broadcasts, etc.) or generated by a local computer (e.g. computer games). The generation of video content by different graphics generating applications may require a considerable amount of computational power, which is costly and not available in many commercial computing systems. Even greater computational power is required when the graphic generation application is required to generate the video content in real time, and in response to external input (which is generally user input such as keyboard strokes and mouse movement, but this is not necessarily so, and other input types may be used in additional or instead of the above mentioned input types).

A known solution for this problem is to carry out the required computations on a remote system (such as a server), and to transmit the video content to a displaying client, which is therefore freed from the need to carry through the major load of computations.

However, the transmission of video content over the internet, for example, or other mediums such as wireless transmission, may suffer from communication factors such as bandwidth and latency. This problem is even more significant if the video content needs to be generated in at least near real time and in response to user input. In such cases, the latency of the communication medium may cause sever problems, which may altogether prevent a transmission of remotely generated near real time video content of acceptable quality, or require significant compromises on video streaming quality.

Furthermore, many graphics generating application are not developed for such a transmission of video, and need to be considerably rebuilt in order to allow for such operation, if at all possible.

The common methods to perform screen delivery use either video streaming or constantly updated single frame delivery. Those methods do not suit highly interactive applications (e.g. games, controlled webcams, robotics etc.) due to either too high latency between image initiation and reception or too little frame rate which is not suitable for intensive dynamic changes of the screen. The problem of the image delivery delay is critical in real time applications but not in video broadcasting. There is a large group of applications that requires both, a real time image delivery together with intensive dynamic changes of the image. There is a need to address the requirements of low latency and acceptable frame rate.

Two main techniques for image and video delivery should be mentioned here. The first is a video streaming based on delivery of compressed video using discrete cosine transform (DCT) based differential compression (e.g. MPEG1, 2, 4, 21), second is streaming of independent images while each of the images could be compressed using different compression algorithms.

In the first aforementioned group of image delivery techniques, to archive greater compression ratios, key images (I-Frames) must follow by as much as possible intermediate, differential frames (B-Frames and P-Frames) while the decoding algorithm could start after the sequence of differential frames is completed. This leads to a grater delay between encoding to decoding due to dependency of differential frames in key frame and between them, as well as a higher complexity of algorithm and as a result, bigger commutation power of the device to perform actual decoding.

In the second group of image delivery techniques, all the images are independent key frames and ready for decoding immediately as received. However the delivery of single image greatly increases the network burdening and as a result lowers the frame rate in a given bandwidth. It should be noted that the technique that is disclosed in relation to an aspect of the invention solves the main problems of both previously mentioned techniques.

In addition any streaming technique using MPEG compression in conjunction with screen capture will provide a poor quality of the details due to its limitation of the macro block based coding. Therefore the video driven compression will not be optimal for our purposes and shows another disadvantage of the current video streaming technique based on standard MPEG codec.

Is should be noted that disadvantages of macro block based coding are significant in terms of quality especially when related to the graphics screen coding, and to a lesser extent when it relates to natural video content, where the level of details is much lower. While a level of quality of MPEG streaming may suffice for natural video (e.g. FPS and BW), the latency occurring in such streaming may result in intolerable overall quality of streaming.

In many instances where streaming of video content may be used, such as in gaming, there is a need for a streaming technique (that may usually be used for various purposes) that offers both lower latency and better quality of details of the graphics content. Especially, those qualities are desirable for the coding of the graphics content/PC screen.

There is therefore a great need for reliable and simple means of providing video content to a target system.

### SUMMARY OF THE INVENTION

A method for providing video content to a target system, the method includes the stages of: (a) acquiring multiple groups of frames from a stream of frames; (b) processing each group of frames out of the multiple groups of frames to provide a video file; and (c) transmitting the video files to the target system; wherein the stages of acquiring, processing and transmitting partially overlap.

A system for providing video content to a target system, the system includes: (a) a frame acquiring module, adapted to acquire multiple groups of frames from a stream of frames; (b) a processing module, adapted to process each group of frames out of the multiple groups of frames to provide a video file; and (c) a video transmission interface, adapted to transmit the video files to the target system; wherein the acquiring, processing and transmitting partially overlap.

A computer readable medium having computer-readable code embodied therein for providing video content, the computer-readable code includes instructions for: (a) acquiring multiple groups of frames from a stream of frames; (b) processing each group of frames out of the multiple groups of frames to provide a video file; and (c) transmitting the video files to the target system; wherein the stages of acquiring, processing and transmitting partially overlap.

### BRIEF DESCRIPTION OF THE DRAWINGS

The foregoing and other objects, features, and advantages of the present invention will become more apparent from the following detailed description of several embodiments of the invention when taken in conjunction with the accompanying drawings. In the drawings, similar reference characters denote similar elements throughout the different views, in which:

FIG. 1 is a block diagram that illustrates a system for providing video content to a target system, according to an embodiment of the invention;

FIGS. 2a and 2b are flowcharts that illustrate a method for providing video content to a target system, according to an embodiment of the invention; and

FIG. 3 illustrates providing video content to a target system, according to an embodiment of the invention.

### DETAILED DESCRIPTION OF THE EMBODIMENTS

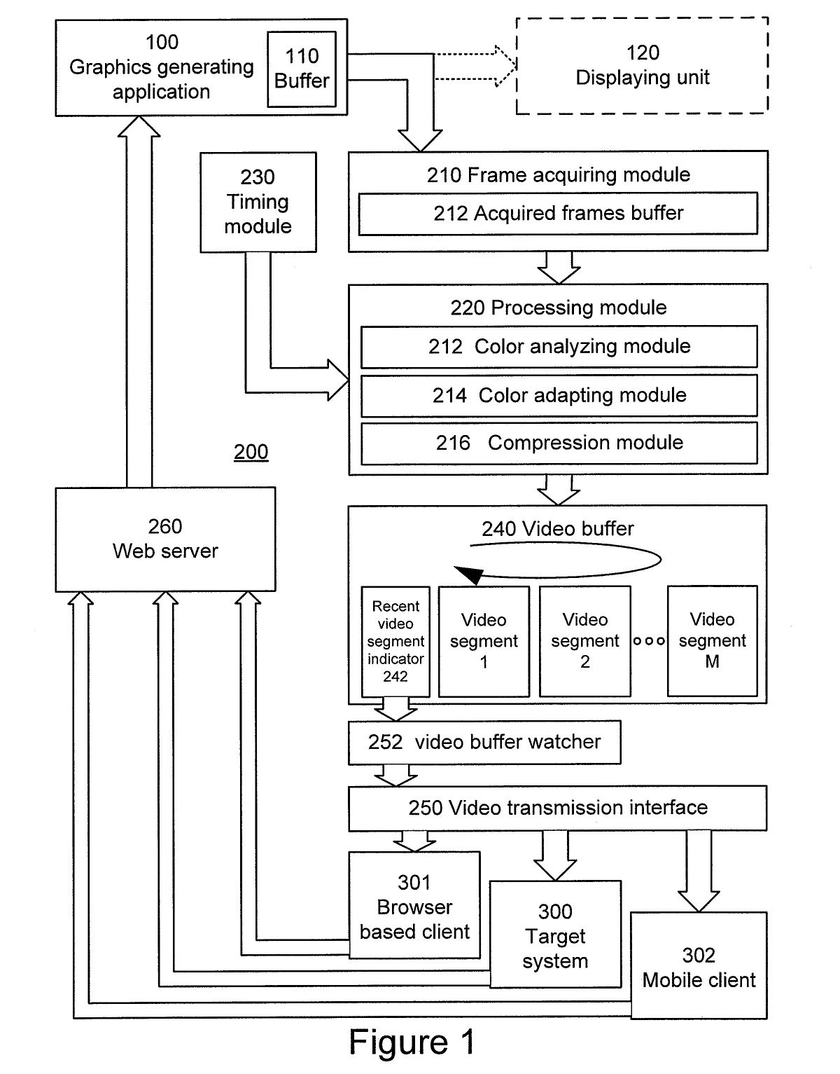

FIG. 1 illustrates system 200 for providing video content to target system 300, according to an embodiment of the invention. System 200 includes: (a) frame acquiring module 210, adapted to acquire multiple group of frames from a stream of frames; (b) processing module 220, adapted to process each group of frames out of the multiple groups of frames to provide a video file; and (c) video transmission interface 250, adapted to transmit the video files to the target system; wherein the acquiring, processing and transmitting partially overlap. It is clear to a person who is skilled in the art that the transmitted video files are conveniently mutually independent. The ways in which different components of system 200 operate according to different embodiments of the invention are described in detail below.

Conveniently, frame acquiring module 210 is adapted to acquire multiple groups of frames by acquiring frame information of multiple frames, wherein the multiple frames are later grouped into groups of frames, wherein the frame information of each frame is conveniently either a raster information including color value for each pixel of the frame, or other information that is usable for the displaying of the frame. Conveniently, the frame information of each frame acquired by frame acquiring module 210 is independent from frame information of other frames, thought this is not necessarily so. Throughout the description of the preferred embodiments, the acquiring of frame information of multiple frames is generally referred to as the frame acquiring module. However, it should be noted that other methods of acquiring multiple groups of frames are applicable, and the particular description of acquiring frame information is not intended to be restrictive in any way as any skilled in the art will understand.

Conveniently, the stream of frames that includes the multiple groups of frames acquired by frame acquiring module 210 is conveniently generated by graphics generating application 100. As graphics generating application 100 is conveniently adapted to prepare video content to be provided to a displaying unit 120 for displaying, the frame information generated by graphics generating application 100 is conveniently ready for direct displaying of frames by a displaying unit 120. By way of example, graphics generating application 100 can generate frames to be displayed by a displaying unit 120 and to store the generated frames in a buffer 110, and to transmit a buffer reading instruction, indicating that at least one frame should be read from buffer 110.

Some accepted standards for such frame information generation include open graphic library (“OpenGL”) and DirectX. Many graphics generating applications 100 are currently designed to implement such protocols in order to instruct a graphics card to generate a graphic output in response to specific instructions provided by the graphics generating application 100, in order for the graphic output to be displayed on a displaying unit 120, which conveniently includes a visual display component for the actual displaying of the graphic. As visual displaying units are conveniently adapted to display the graphics frame by frame, independently of previously displayed frames, a frame information for each of the frames that ought to be displayed is provided to the displaying unit 120.

Frame acquiring module 210 is therefore conveniently adapted to acquire frame information of frames that are ready to be displayed on a displaying unit 120, and to grab them instead of any displaying unit 120. It is clear to a person who is skilled in the art that system 200 need not include displaying unit 120, as only the grabbing operation is required.

That is, according to an embodiment of the invention, frame acquiring module 210 is adapted to acquire display information, which is information ready to be directly utilized for displaying of graphics by displaying unit 120 (and especially on a monitor thereof). As graphics generating application 100 may not be designed to transmit frame information to frame acquiring module 210 but rather to displaying units 120, frame acquiring module 210 may be adapted to hook such frame information. Thus, according to an embodiment of the invention, frame acquiring module 120 is adapted to acquire frame information in response to a frame buffer reading instruction, that is provided by graphics generating application 100 and is intended to instruct a displaying unit 120 to read frame information, e.g. from buffer 110. According to an embodiment of the invention, frame acquiring module 210 is further adapted to distinguish between such information (e.g. OpenGL displaying information) and between information that should not be acquired.

According to an embodiment of the invention, frame acquiring module 210 is adapted to determine if available information (e.g. one that is provided by graphics generating application 100, also information from multiple applications may be available to frame acquiring module 210) should be acquired as frame information, and to acquire frame information in response to such a determination.

Conveniently, frame acquiring module 210 is adapted to monitor a frame information source over long periods of time, and to acquire frame information of multiple frames over time, wherein the frames are divided into sequential groups of frames, wherein all the frames included in a second group of frames were acquired later than any of the frames included in a first group of frames.

For the sake of an example, it is noted that conveniently frame acquiring module 210 is adapted to: (a) acquire, at a first period of time, frame information of frames that are included in a first group of frames; and to (b) acquire, at a second period of time that is later than the first period of time, frame information of frames that are included in a second group of frames. It is however noted that the dividing of the acquired frames into different groups of frames is not necessarily carried out by frame acquiring module 210, and that a multitude of frames acquired by frame acquiring module 210 could be divided into groups of frames later in the process, e.g. by processing module 220.

According to an embodiment of the invention, frame acquiring module 210 includes (or, according to another embodiment of the invention, is otherwise connected to) acquired frames buffer 212, that is adapted to store at least some acquired frame information that was acquired by frame acquiring module 210, usually for later retrieving by processing module 220.

Continuing the same example, processing module 220, in turn, is conveniently adapted to: (a) process frame information of multiple frames of the first group of frames, so as to generate a first video file; and to (b) process frame information of multiple frames of the second group of frames, so as to generate a second video file. Generally, processing module 220 is conveniently adapted to group acquired frames into multiple sequential groups of frames, and then to process the frame information of some or all of the frames included in each of the groups of frame, to provide a series of video files that are mutually independent (i.e. the decoding as well as the displaying of each of the video files does not require any of the other video files, with possible exception of timing parameters), to be provided to target system 300. Especially, the aforementioned first video file and second video file are mutually independent.

It is clear to a person who is skilled in the art that different sorts of video compressing techniques (such as those associated with different video compression standards) may be implemented for the generation of the video files, albeit conveniently a single video standard is conveniently used for all the video files that are generated in response to frame information received from a single stream of frames acquired (that is generated by a single graphics generating application 100) which are to be transmitted to a single target system 300 (or at least to a single displaying application thereof).

The implemented video files may be encoded in different ways, such as (though not limited to) compressed video, uncompressed video, video that include inter-frames encoding, and so forth. According to an embodiment of the invention, the implemented video standard is animated images (such as animated graphics interchange format—animated GIF, e.g. according to the GIF89a standard), wherein processing module 220 is adapted to process frame information of multiple frames of each group of frames, so as to provide an animated image file.

According to an embodiment of the invention, processing module 220 is adapted to process each group of frames, so as to generate a video file that corresponds to a certain video encoding out of multiple types of video encoding implementable by processing module 220, wherein processing module 220 is further adapted to select a video encoding to be used for video files generation. The selection of the video encoding type may depend on multiple factors, such as content of video content processed (which may be either indicated by graphics generating application 100 or analyzed by processing module 220), type of target displaying application in target system 300, available computational power (e.g. if processing videos for multiple clients), duration of each video file, available bandwidth, communication channel latency, and so forth. It is clear that, according to such embodiment of the invention, processing module 220 could select a first type of video encoding for a first series of video files and a second type of video encoding for a second series of video files.

The grouping of frames into groups of frames is conveniently responsive to a period of time of each group of frames (which is conveniently indicated in time or in number of frames). For example, each group of frames may include N frames, which are conveniently successive frames (even though according to an embodiment of the invention not all the frames should be processed, e.g. for a very low bandwidth communication channel). According to an embodiment of the invention, system 200 further includes timing module 230 that is adapted to provide timing information for the grouping of the frames into groups of frames.

According to an embodiment of the invention, processing module 220 is adapted to group frames into groups of frames according to timing information. According to an embodiment of the invention, processing module 220 is adapted to group frames into groups of frames by counting a predetermined number of frames. It is however noted that according to some embodiments of the invention, not all the groups of frames should necessarily include the same number of frames or to correspond to a same video duration. The grouping criterion could also be changed in different times, e.g. in response to a change in the characteristics of the communication channel.

According to an embodiment of the invention, processing module 220 is further adapted to analyze colors of at least one frame of a group of frames when processing the group of frames (this could be carried out, by way of example, by a color analyzing module 222). Specifically, according to an embodiment of the invention, processing module 220 is adapted to analyze colors of some or all of the frames of a group of frames (by analyzing the respective frame information), so as to determine palettes of color, either for each analyzed frame, or for each group of frames (wherein the latter could be achieved, for example, by processing the former), wherein the encoding of the video file is responsive to the color analysis (and especially, according to an embodiment of the invention, to the determined palettes).

According to an embodiment of the invention, processing module 220 is adapted to encode frame information of one or more frames using a lower color depth than originally acquired by frame acquiring module 210 (e.g. by color adapting module 214). By way of example, processing module 220 can process true color frames (i.e. having color-depth of 24 bit) to frames of a lower color-depth (e.g. 8 bit), conveniently in response to at least one previously determined palette.

Conveniently, processing module 220 is adapted to compress video file information when processing a group of frame. The color adaptation described above is only one way of compressing information, and many other compressing methods, either lossy or lossless, many of which are known in the art.

According to an embodiment of the invention, processing module 220 is adapted to timestamp each video file with a timestamp that indicates when the video file is to be played.

Video files of the series of generated video files, each of which corresponds to a period of time of the stream of frames conveniently provided by graphics generating application 100, thus need to be provided to target system 300, to be displayed to a user. As video files are conveniently continuously transmitted to target system 300 for near real time displaying, only video files that include recently generated though not yet transmitted video files should be available for transmission to target system 300. It is noted that if even a generated video file was not transmitted, it can usually be discarded after a predetermined period, because it no longer includes relevant information for near real time displaying.

Therefore, according to an embodiment of the invention, system 200 includes video buffer 240, that is adapted to store a predetermined number of video files that ought to be transmitted to target system 300. According to an embodiment of the invention, video buffer 240 is further adapted to store recent video file indicator 242 (which may be a signal file, but this is not necessarily so), that indicates which is the most recent video file stored in video buffer 240, for the transmitting of the most recent video file to target system 300. Alternatively, an indicator may be included to indicate the oldest video file not older than a predetermined value (e.g. a second), in order to be transmitted to target system 300. As aforementioned, only a limited amount of video files should usually be buffered (as there is usually no use to store too old video files), and as video files are continuously transmitted, transmitted video files or aged video files could be over written so as to store newer not yet transmitted video files generated by processing module 220.

According to an embodiment of the invention, processing module 220 is adapted to replace, following the processing of each group of frames, a previous video with the provided video file in a video files buffer (conveniently video buffer 240); and wherein video transmission interface 250 is adapted to transmit video files from the video files buffer to target system 300.

As aforementioned, some video files may not be transmitted to target system 300 for different reasons, and become too old to be relevant. As those files may be determined not worthy for transmitting, according to an embodiment of the invention, processing module 220 is further adapted to replace a previous video file that was not transmitted to target system 300 with the provided video file.

Generally speaking, according to an embodiment of the invention, system 200 is further adapted to determine a video file to be transmitted, wherein video transmission interface 250 is adapted to selectively transmit video files to target system 300 in response to results of the determination. It is noted that the determining of which video files are to be transmitted may also be carried out by target system 300, or by a negotiation between the two systems 200 and 300.

As aforementioned, system 200 includes video transmission interface 250 that is adapted to provide video files to target system 300. Referring again to the example noted above, video transmission interface 250 is adapted to provide the first video file and the second video file to target system 300, wherein the providing of the second video file follows the providing of the first video file.

According to an embodiment of the invention, video transmission interface 250 is a web server (e.g. an HTTP server) that is adapted to provide video files to target system 300 over internet protocol (IP) medium, but this is not necessarily so.

According to an embodiment of the invention, the providing of the video files to target system 300 by video transmission interface 250 is responsive to the timestamps of the different video files (which are in such a case conveniently included in the video files by processing module 220). It is noted that according to an embodiment of the invention, system 200 includes video buffer watcher 252, that is adapted to indicate to video transmission interface 250 which video file to provide to target system 300.

It is noted that as target system 300 may run different displaying application (e.g. internet browsers, a displaying application dedicatedly adapted to communicate with system 200, and so forth), the displaying application on target system 300 may usually either continuously receive video files from system 200 upon pushing of said video files by system 200, or request system 200 for video files. To support the latter, according to an embodiment of the invention, system 200 is further adapted to transmit to target system 300 video file information, for the retrieving of a video file by target system 300.

It is noted that different embodiments of system 200 are conveniently adapted to provide video files to one or more types of target systems 300 (and thus to one or more types of displaying applications running on one or more types of target systems 300). Two different types of target systems 300 are a browser based client (denoted 301) and a mobile client (e.g. a cellular phone, a personal digital assistant, and so forth, denoted 302).

Conveniently, those types of target systems 300 support hypertext transfer protocol (HTTP), but it is noted that other protocols are implemented according to different embodiments of the invention. According to an embodiment of the invention, system 200 is adapted to provide video files to target system 300 according to the hypertext transfer protocol.

As aforementioned, the stream of frames may be generated by a graphics generating application 100 in response to input information received from a user (usually a user that uses target system 300). For example, graphics generating application 100 may be a video providing game, wherein the user may provide to the video providing game different types of inputs (usually using an input interface of target system 300 or a peripheral thereof, such as a keyboard, a mouse, a joystick, a microphone, a touch-screen, a control pad, and so forth).

It is again noted that, according to an embodiment of the invention, graphics generating application 100 may be originally designed to run on a single system, that includes a processing module that is adapted to run graphics generating application 100, at least one input device for the receiving of inputs from a user, and a displaying unit 120 for the displaying of the video content generated by graphics generating application 100.

Similar to a way in which system 200 may intercept frame information generated by a graphics generating application 100 which is originally destined to a displaying unit 120, according to some embodiments of the invention, system 200 is adapted to receive, from an external system, input (which is conveniently target system 300), that is influential for the generating of the stream of frames (such as inputs used by graphics generating application 100 in the generating of the video content).

This could be done, for example, by emulating input devices for graphics generating application 100, by using program hooks designed in graphics generating application 100 for that purpose, or in other ways many of which are known in the art. It is further noted that the receiving of inputs from the external system may require installation of a client that is adapted to provide the inputs to system 200 on the external system. It is noted that the receiving of at least one input from said external system may be implemented by web server 260, but this is not necessarily so.

It is noted that, according to an embodiment of the invention, system 200 (and especially processing module 220) is adapted to run graphics generating application 100, that is adapted to provide the stream of frames (or to otherwise generate one or more streams of frames for acquiring). According to such embodiments of the invention, graphics generating application 100 may be either be dedicatedly adapted to run on a system such as system 200, or be a non-dedicated graphics generating application, wherein system 200 is adapted to facilitate providing of stream of frames generated by said non-dedicated graphics generating application to target system 300 (and especially to a remote target system 300), in the manner disclosed above.

According to an embodiment of the invention, system 200 is adapted to acquire frame information from multiple sources, to process multiple streams of frames, so as to generate multiple video files, and to provide the multiple video files to at least one target system 300. According to an embodiment of the invention, system 200 is adapted to provide video files to multiple target systems 300, wherein different target systems 300 may be provided by system 200 with either the same video files, or with at least some different video files (which may be either generated in response to different streams of frames or to the same stream of frames, such as when different external systems 300 are connected to system 200 with communication channels that have different characteristics, and thus may receive at least partly different video files).

Referring to issues of frame rate, displaying rate, refreshing rate, latency times, available bandwidth and so forth, which may make the transmitting of video content to target system 300 more difficult, and which the invention seeks to overcome, it is noted that conveniently, each group of frames is characterized by a display rate; and video transmission interface 250 is adapted to transmit the video files to target system 300 in response to a target rate (e.g. a target rate pertaining to any of the issues herein mentioned) that is substantially slower than the display rate.

Additionally, it would be clear to a person who is skilled in the art that in different embodiments of the invention, components of system 200 which were described separately from each other may be implemented as a unified component adapted to carry out operation described in relation to two or more of the components of system 200, and likewise, any of the components of system 200 may be implemented using more than a single instance thereof; for example, system 200 may include multiple processing modules, multiple interfaces and so forth.

It is clear to a person who is skilled in the art that system 200 as herein disclosed may be implemented in different manners, which may include, for example, hardware components, software components, firmware components, or any combination thereof.

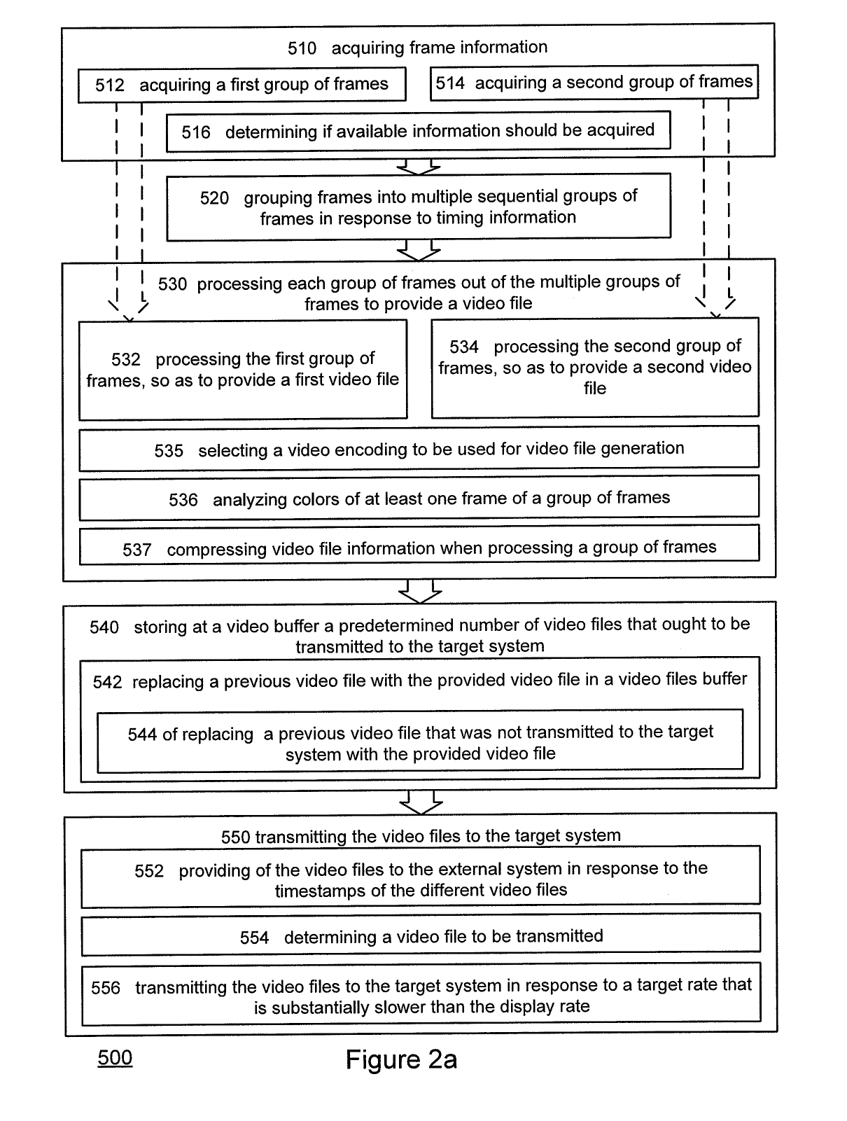

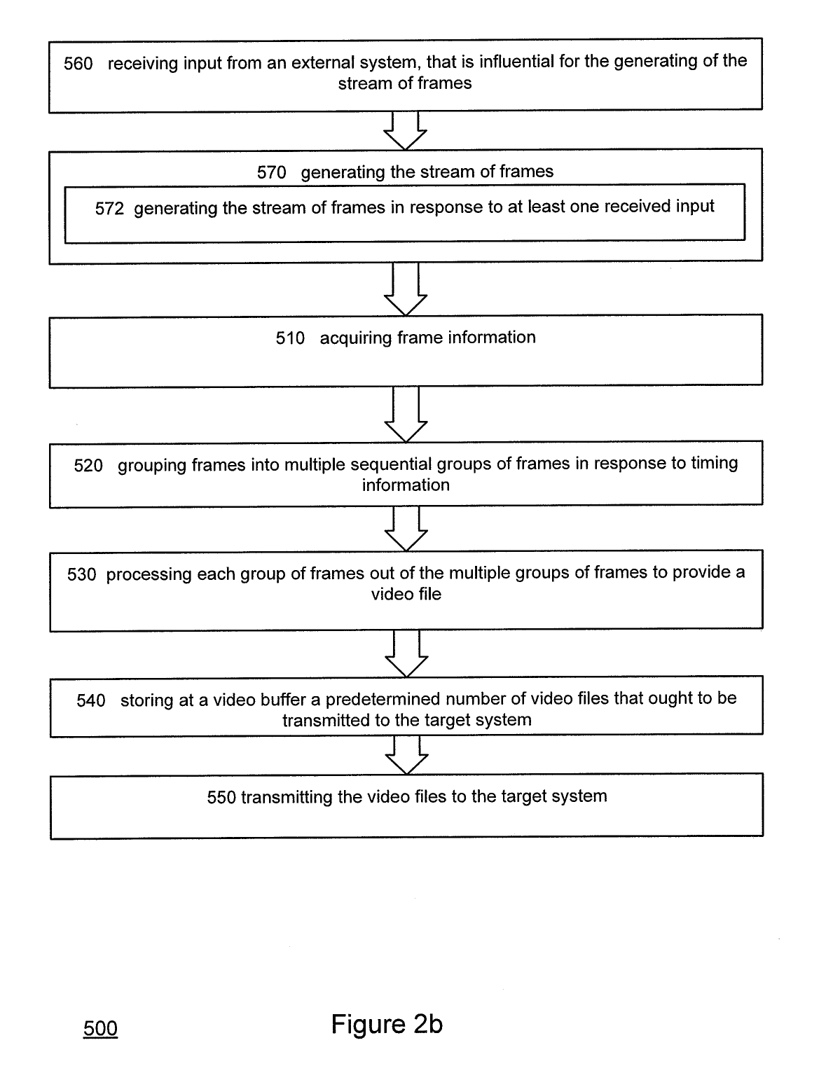

FIGS. 2a and 2b illustrates method 500 for providing video content to a target system, according to an embodiment of the invention. It should be noted that conveniently, method 500 is adapted to be carried out by system 200, and thus different embodiments of method 500 are conveniently adapted to be carried out by different embodiments of system 200. Referring again to system 200, it is hence noted that conveniently, system 200 is adapted to carry out method 500, and thus different embodiments of system 200 are conveniently adapted to carry out different embodiments of method 500.

Referring to FIG. 2a, method 500 conveniently starts with stage 510 of acquiring multiple groups of frames from a stream of frames. It should be noted that the acquiring of the multiple groups of frames partially overlaps the stages of processing and transmitting discussed below.

In order to clarify the invention, an example is offered, according to which stage 510 includes stage 512 of acquiring at a first period of time, a first group of frames, and stage 514 of acquiring, at a second period of time that is later than the first period of time, a second group of frames. Referring to the examples set forward in the previous drawings, stage 510 is conveniently carried out by frame acquiring module 210.

Conveniently, the acquiring of the multiple groups of frames is carried out by acquiring frame information of multiple frames, wherein the multiple frames are later grouped into groups of frames, wherein the frame information of each frame is conveniently either a raster information including color value for each pixel of the frame, or other information that is usable for the displaying of the frame.

Conveniently, the frame information of each frame acquired is independent from frame information of other frames, though this is not necessarily so. Throughout the description of the invention, it is generally referred to the acquiring of frame information of multiple frames; however, it should be noted that other methods of acquiring multiple groups of frames are applicable, and the description of acquiring frame information is not intended to be restrictive in any way.

It is noted that the stream of frames that includes the multiple groups of frames that is acquired during stage 510 is conveniently generated by a graphics generating application. As the graphics generating application is conveniently adapted to prepare video content to be provided to a displaying unit, the frame information generated by the graphics generating application is conveniently ready for direct displaying of frames by a displaying unit 120. By way of example, the graphics generating application can generate frames to be displayed by a displaying unit and to store the generated frames in a buffer, and to transmit buffer reading instruction, indicating that at least one frame should be read from buffer.

Some accepted standards for such frame information generation include open graphic library (“OpenGL”) and DirectX. Many graphics generating applications are currently designed to implement such protocols in order to instruct a graphics card to generate a graphic output in response to specific instructions provided by the graphics generating application, in order for the graphic output to be displayed on a displaying unit, which conveniently includes a visual display component for the actual displaying of the graphic. As visual displaying units are conveniently adapted to display the graphics frame by frame, independently of previously displayed frames, frame information for each of the frames that ought to be displayed is provided to the displaying unit.

The acquiring of stage 510 therefore conveniently includes acquiring frame information of frames that are ready to be displayed on a displaying unit, e.g. by grabbing them instead of any displaying unit. It is clear to a person who is skilled in the art that a system which carries out method 500 need not include a displaying unit, as only the grabbing operation is conveniently required.

That is, according to an embodiment of the invention, the acquiring of stage 510 includes acquiring display information, which is information ready to be directly utilized for displaying of graphics by a displaying unit (and especially on a monitor thereof). As the graphics generating application may not be designed to transmit frame information to a system that is adapted to carry out method 500, but rather to displaying units, the acquiring of stage 510 may include hooking such frame information.

Thus, according to an embodiment of the invention, the acquiring may include acquiring frame information in response to a frame buffer reading instruction, that is provided by the graphics generating application and is intended to instruct a displaying unit to read frame information, usually from a dedicated buffer.

According to an embodiment of the invention, the acquiring includes distinguishing between such information (e.g. OpenGL displaying information) and between information that should not be acquired.

According to an embodiment of the invention, stage 510 includes stage 516 of determining if available information (e.g. one that is provided by the graphics generating application, also information from multiple applications may be available) should be acquired, wherein the acquiring is responsive to a result of the determining.

Conveniently, the acquiring is facilitated by a monitoring of a source of stream of frames over long periods of time that constitutes a part of method 500 according to an embodiment of the invention. The acquiring thus conveniently includes acquiring frame information of multiple frames over time, wherein the frames are divided into sequential groups of frames, wherein all the frame included in a second group of frames were acquired later than any of the frames included in a first group of frames.

It is however noted that the dividing of the acquired frames into groups of frames is not necessarily carried out during stage 510, and that a multitude of frames acquired during the acquiring could be divided into groups of frames later in the process, e.g. during stage 520 discussed below.

According to an embodiment of the invention, the acquiring includes storing at least some acquired frame information that was acquired during the acquiring at a acquired frames buffer, usually for later retrieving and processing as disclosed in relation to stage 530.

According to an embodiment of the invention, stage 510 is followed by stage 520 of grouping frames into multiple sequential groups of frames in response to timing information. Referring to the examples set forward in the previous drawings, stage 520 is conveniently carried out by processing module 220.

The grouping of frames into group of frames is conveniently responsive to a period of time of each group of frames (which is conveniently indicated in time or in number of frames). For example, each group of frames may include N frames, which are conveniently successive frames (even though according to an embodiment of the invention not all the frames should be processed, e.g. for a very low bandwidth communication channel). According to an embodiment of the invention, the grouping of stage 520 is responsive to timing information.

According to an embodiment of the invention, the grouping includes grouping frames into groups of frames by counting a predetermined number of frames. It is however noted that according to some embodiments of the invention, not all the groups of frames should necessarily include the same number of frames or to correspond to a same video period of time. The grouping criterion could also be changed in different times, e.g. in response to a change in the characteristics of the communication channel.

Method 500 continues with stage 530 of processing each group of frames out of the multiple groups of frames to provide a video file. Continuing the example offered above, stage 530 includes stage 532 of processing the first group of frames, so as to provide a first video file, and stage 534 of processing the second group of frames, so as to provide a second video file; wherein the first video file and the second video file are mutually independent. Referring to the examples set forward in the previous drawings, stage 530 is conveniently carried out by processing module 220.

It should be noted that method 500 is conveniently iterated for relatively long periods of time, and that the stages of acquiring, processing, and providing (and other stages of method 500) are conveniently repeated over and over many times. It should especially be noted that the processing partially overlaps the stages of acquiring, and transmitting, and well as conveniently other stages of method 500. It is noted that the processing of the first group of frames may at least partially precede the acquiring of the second groups of frames, though this is not necessarily so.

The processing conveniently includes processing the frame information of some or all of the frame included in each of the groups of frame, to provide a series of video files that are mutually independent (i.e. the decoding as well as the displaying of each of the video files does not require any of the other video files, with possible exception of timing parameters), to be provided to the target system. Especially, the aforementioned first video file and second video file are mutually independent.

It is clear to a person who is skilled in the art that different sorts of video standards may be implemented for the generation of the video files, albeit conveniently a single video standard is conveniently used for all the video files that are generated in response to a single stream of frames. The implemented video files may be encoded in different ways, such as (though not limited to) compressed video, uncompressed video, video that include inter-frames encoding, and so forth.

According to an embodiment of the invention, the implemented video standard is animated images (such as animated graphics interchange format—animated GIF, e.g. according to the GIF89a standard), wherein the processing includes processing each group of frames, so as to provide an animated image. It is noted that processing unit 220 may be further adapted to include display timing information pertaining to different frames of the video image file.

According to an embodiment of the invention, stage 530 includes processing each group of frames, so as to provide a video file that corresponds to a certain video encoding out of multiple types of video encoding and is implementable in a system that carries out stage 530, wherein the processing includes stage 535 of selecting a video encoding to be used for video files generation.

The selecting of the video encoding type may depend on multiple factors, such as content of video content processed (which may be either indicated by the graphics generating application or analyzed for the selecting of stage 535), type of target displaying application in the external system, available computational power (e.g. if processing videos for multiple clients), period of time of each video file, available bandwidth, communication channel latency, and so forth. It is clear that, according to such an embodiment of the invention, the selecting of stage 535 may include selecting a first type of video encoding for a first series of video files and a second type of video encoding for a second series of video files.

According to an embodiment of the invention, the processing includes stage 536 of analyzing colors of at least one frame of a group of frames. Specifically, according to an embodiment of the invention, the processing includes analyzing colors of some or all of the frames of a group of frames (by analyzing the respective frame information), so as to determine palettes of color, either for each analyzed frame, or for each group of frames (wherein the latter could be achieved, for example, by processing the former), wherein the encoding of the video file is responsive to the color analysis (and especially, according to an embodiment of the invention, to the determined palettes).

According to an embodiment of the invention, the processing includes encoding frame information of one or more frames using a lower color depth than originally acquired during stage 510. By way of example, the processing may include processing true color frames (i.e. having color-depth of 24 bit) to frames of a lower color-depth (e.g. 8 bit), conveniently in response to at least one previously determined palette.

Conveniently, the processing includes stage 537 of compressing video file information when processing a group of frames. The color adaptation described above is only one way of compressing information, and many other compressing methods, either lossy or lossless, may be employed—many of which are known in the art.

According to an embodiment of the invention, the processing includes time-stamping each video file with a timestamp that indicates when the video file is to be played.

Video files of the series of generated video files, each of which corresponds to a period of time of video content conveniently provided by the graphics generating application, thus needs to be provided to the target system, to be displayed to a user. As video files are conveniently continuously provided to the target system for near real time displaying, only video files that include recently generated, though not yet transmitted, video files should be available for transmission to the target system. It is noted that if even a generated video file was not transmitted, it can usually be discarded after a predetermined period, because it no longer includes relevant information for near real time displaying.

Therefore, according to an embodiment of the invention, method 500 includes stage 540 of storing at a video buffer a predetermined number of video files that ought to be transmitted to the target system. According to an embodiment of the invention, the storing operation includes storing a recent video file indicator which may be a signal file, but this is not necessarily so, that indicates which is the most recent video file stored in the video buffer, for transmitting the most recent video file to the target system. Alternatively, an indicator may be included to indicate the oldest video file not older than a predetermined value (e.g. a second), in order to be transmitted to the target system. As aforementioned, only a limited amount of video files should usually be buffered (as there is usually no use to store too old video files), and as video files are continuously transmitted, transmitted video files or aged video files could be over written so as to store newer not yet transmitted video files generated during the processing.

According to an embodiment of the invention, method 500 includes stage 542 of replacing a previous video with the provided video file in a video files buffer, following the processing of each group of frames. It is noted that according to such embodiment, the stage of transmitting detailed below includes transmitting video files from the video files buffer to the target system.

Especially, according to an embodiment of the invention, stage 542 includes stage 544 of replacing a previous video file that was not transmitted to the target system with the provided video file.

Method 500 continues with stage 550 of transmitting the video files to the target system; wherein it is mentioned again that the stages of acquiring, processing and transmitting partially overlap. Returning to the example offered above, the providing operation may include providing the first video file and the second video file to the target system, wherein the providing of the second video file follows the providing of the first video file. It is noted that, conveniently, the providing of different video files, and especially the providing of the first video file and the providing of the second video file, are also mutually independent. Referring to the examples set forward in the previous drawings, stage 550 is conveniently carried out by video transmission interface 250.

According to an embodiment of the invention, the providing operation is facilitated by a web server (e.g. an HTTP server) that is adapted to provide video files to the target system over internet protocol (IP) medium, but this is not necessarily so.

According to an embodiment of the invention, stage 550 includes stage 552 of providing the video files to the target system in response to the timestamps of the different video files (which in such a case are conveniently included in the video files during stage 530 of processing). It is noted that according to an embodiment of the invention, stage 550 includes indicating by a video buffer watcher which video file to provide to the target system.

As aforementioned, not all video files are necessarily provided (as some of which may aged before being provided, e.g. due to temporal communication difficulties), and therefore, according to an embodiment of the invention, stage 550 includes stage 554 of determining a video file to be transmitted, wherein the transmitting operation includes selectively transmitting video files to the target system in response to the determined video file. It is noted that optionally, at least one generated video file is not provided to the target system.

It is noted that as the target system may run different displaying application (e.g. internet browsers, a displaying application dedicatedly adapted to communicate with a system that is adapted to carry out method 500, and so forth), the displaying application on the target system may usually either continuously receive video files from the system upon pushing of the video files by said system, or request the system for video files. To support the latter, according to an embodiment of the invention, stage 550 includes providing to the target system video file information, for the retrieving of a video file by the target system.

It is noted that different embodiments of method 500 are conveniently directed for the providing of video files to one or more types of target systems (and thus to one or more types of displaying applications running on one or more types of target systems). Two different types of target systems are a browser based client and a mobile client (e.g. a cellular phone, a personal digital assistant, and so forth).

Conveniently, those types of target systems support hypertext transfer protocol (HTTP), but it is noted that other protocols are implemented according to different embodiments of the invention. According to an embodiment of the invention, stage 550 includes providing video files to target system according to the hypertext transfer protocol, conveniently as mutually independent video files.

Referring to issues of frame rate, displaying rate, refreshing rate, latency times, available bandwidth and so forth, which may make the transmitting of video content to the target system more difficult, and which the invention seeks to overcome, it is noted that conveniently, each group of frames is characterized by a display rate; and that the transmitting of stage 550 includes stage 556 of transmitting the video files to the target system in response to a target rate (e.g. a target rate pertaining to any of the issues herein mentioned) that is substantially slower than the display rate.

Referring to FIG. 2b, the frame information may be generated, as aforementioned, by a graphics generating application in response to input information received from a user (usually a user that uses the target system). For example, the graphics generating application may be a video providing game, wherein the user may provide to the video providing game different types of inputs (usually using an input interface of an external system or a peripheral thereof, such as a keyboard, a mouse, a joystick, a microphone, a touch-screen, a control pad, and so forth).

It is again noted that, according to an embodiment of the invention, the graphics generating application may be originally designed to run on a single system, that includes a processing module that is adapted to run the graphics generating application, at least one input device for the receiving of inputs from a user, and a displaying unit for the displaying of the video content generated by the graphics generating application.

Similar to a way in which method 500 may include intercepting frame information generated by a graphics generating application which is originally destined to a displaying unit, according to some embodiments of the invention, method 500 includes stage 560 of receiving, from an external system, input (which is conveniently the target system), that is influential for the generating of the stream of frames (such as inputs used by the graphics generating application in the generating of the video content). This could be done by emulating input devices for the graphics generating application, by using hooks designed in the graphics generating application for that purpose, or in other ways, many of which are known in the art. It is noted that the receiving of inputs from the external system may require installation of a client on the external system that is adapted to provide the inputs to the system that carries out method 500.

It is noted that, according to an embodiment of the invention, method 500 is facilitated by running the graphics generating application, that is adapted to provide the frames information of the multiple frames acquired during the acquiring.

According to an embodiment of the invention, method 500 includes stage 570 of generating the stream of frames, wherein stage 570 conveniently includes stage 572 of generating the stream of frames in response to at least one received input. It is however noted that the generating of the frame information of the multiple frames, and thus also the generating of such frame information in response to at least one received input, may be implemented by a system other than that which carries out the other stages of method 500, wherein in such case stage 560, if implemented is conveniently followed by providing at least one received input (and conveniently all of them) to the other system.

According to such embodiments of the invention, the graphics generating application may be either be dedicatedly adapted to run on a system such as the one which carries out method 500, or be a non-dedicated graphics generating application, wherein the system which carries out method 500 is conveniently adapted to facilitate providing of video content generated by said non-dedicated graphics generating application to the target system (and especially to a remote target system), in the manner disclosed above.

Referring now to method 500 in general, according to an embodiment of the invention, the acquiring operation includes: acquiring multiple groups of frames from multiple streams of frames, wherein each group of frames is acquired from a single stream of frames; and the providing operation includes transmitting the multiple video files to at least one target system.

According to an embodiment of the invention, method 500 includes providing video files to multiple target systems, wherein different target systems may be provided with either the same video files, or with at least some different video files (which may be either generated in response to different video contents or to the same video content, such as when different target systems are connected to the system that carries out method 500 with communication channels that have different characteristics, and thus may receive at least partly different video files).

According to an aspect of the invention, a computer readable medium having computer-readable code embodied therein for providing video content is disclosed, wherein the computer-readable code includes instructions for: (a) acquiring multiple groups of frames from a stream of frames; processing each group of frames out of the multiple groups of frames to provide a video file; and transmitting the video files to the target system; wherein the stages of acquiring, processing and transmitting partially overlap.

It is will be clear to a person who is skilled in the art that the herein disclosed computer readable code conveniently implements method 500 by way of computer readable code, and that different embodiments of the computer readable code are implementable for the implementing of different embodiments of method 500, even if not explicitly disclosed. Specifically, some implementations of the computer-readable code are disclosed below.

According to an embodiment of the invention wherein each group of frames is characterized by a display rate; the instructions for transmitting included in the computer-readable code further include instructions for transmitting in response to a target rate that is substantially slower than the display rate.

According to an embodiment of the invention, the computer-readable code further includes instructions for replacing, following the processing of each group of frames, a previous video with the provided video file in a video files buffer; and wherein the instructions for transmitting included in the computer-readable code further include instructions for transmitting video files from the video files buffer to the target system.

According to an embodiment of the invention, the instructions for replacing included in the computer-readable code further include instructions for replacing a previous video file that was not transmitted to the target system with the provided video file.

According to an embodiment of the invention, the instructions for acquiring included in the computer-readable code further include instructions for acquiring display information.

According to an embodiment of the invention, the instructions for processing included in the computer-readable code further include instructions for analyzing, during the processing of at least one group of frames, colors of at least one frame of the group of frames.

According to an embodiment of the invention, the computer-readable code further includes instructions for grouping frames into multiple sequential groups of frames in response to timing information.

According to an embodiment of the invention, the computer-readable code further includes instructions for receiving, from an external system, input that is influential for the generating of the stream of frames.

According to an embodiment of the invention, the computer-readable code further includes instructions for generating the stream of frames.

According to an embodiment of the invention, the computer-readable code further includes instructions for determining a video file to be transmitted, and wherein the instructions included in the computer readable code for transmitting includes instructions for selectively transmitting video files to the target system in response to results of the determining operation.

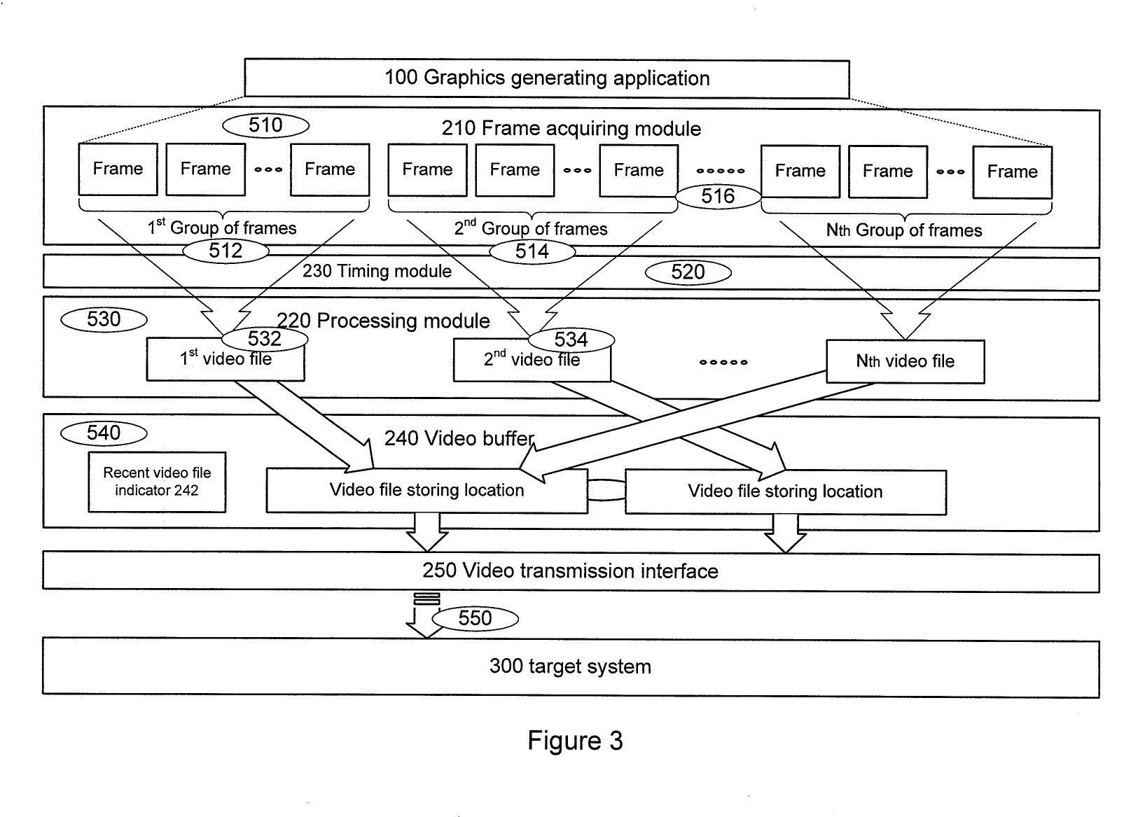

FIG. 3 illustrates providing video content to a target system, according to an embodiment of the invention. It is noted that the providing of video content as described in FIG. 3 can be implemented according to the methods, to the systems and to the computer program products disclosed above. FIG. 3 illustrates, by way of an example only, how system 200 and method 500 could be combined for the providing of video.

Graphics generating application 100 conveniently prepares video content that is ready for direct displaying of frames by a displaying unit 120. The frames of the video content (exemplified by the boxes denoted “Frame” in FIG. 3) are acquired by 210 frame acquiring module during stage 510 into different groups of frames (e.g. first group of frames (so denoted) during stage 512, and second group of frames (so denoted) during stage 514). Frame acquiring module 210 may also periodically determine where available information should be determined, denoted 516.

The grouping of frames may be responsive to timing information generated by timing module 230 (see stage 520).

Processing module 220 processes each group of frames out of the multiple group of frames, to provide a video files (denoted 1^{st} video file, 2^{nd} video file, and so forth). The operation of processing module is discussed in relation to stage 530 of method 500, and different aspects of that operation are detailed in sub-stages of stage 530.

The video files generated by processing module 220 are ready for transmission to target system 300. However, a buffering of the video files may be required (as in stage 540 of method 500), wherein the video files are then buffered in video buffer 240. According to an embodiment of the invention, limited amount of buffers (e.g. two, as exemplified in FIG. 3, denoted “video file storing location”) may be used, wherein video files may be written alternately to the different buffers, overwriting previous files. A recent video file indicator 242 may indicate the last buffer to which a video file was written.

The video files generated by processing module 220 (whether after buffering or directly, according to different embodiments of the invention) are transferred to video transmission interface 250 for transmission (as in stage 550 of method 500) to target system 300, which is usually a remote target system.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A method for providing video content to a target system, the method comprising:
acquiring multiple groups of frames from a stream of frames;
processing each group of frames out of the multiple groups of frames to provide a video file; and
transmitting the video file to the target system; wherein the acquiring, processing and transmitting partially overlap.

2. The method according to claim 1, wherein each group of frames is characterized by a display rate; and wherein the transmitting is responsive to a target rate that is substantially slower than the display rate.

3. The method according to claim 1, wherein the processing of each group of frames is followed by replacing a previous video with the provided video file in a video files buffer, and wherein the transmitting comprises transmitting video files from the video files buffer to the target system.

4. The method according to claim 3, wherein the replacing comprises replacing a previous video file that was not transmitted to the target system with the provided video file.

5. The method according to claim 1, wherein the acquiring comprises acquiring display information.

6. The method according to claim 1, wherein the acquiring comprises acquiring each frame in response to a frame buffer reading instruction.

7. The method according to claim 1, wherein the processing of at least one group of frames comprises analyzing colors of at least one frame of the group of frames.

8. The method according to claim 1, further comprising determining a video file to be transmitted, wherein the transmitting comprises selectively transmitting video files to the target system in response to the determined video file.

9. The method according to claim 1, further comprising determining if available information should be acquired, wherein the acquiring is responsive to a result of the determining.

10. The method according to claim 1, further comprising grouping frames into multiple sequential groups of frames in response to timing information.

11. The method according to claim 1, further comprising receiving, from an external system, input that is influential for the generating of the stream of frames.

12. The method according to claim 1, further comprising generating the stream of frames.

13. The method according to claim 1, wherein the acquiring comprises acquiring multiple groups of frames from multiple streams of frames, wherein each group of frames is acquired from a single stream of frames, and wherein the transmitting comprises transmitting the video files to at least one target system.

14. A system for providing video content to a target system, the system comprises:
a frame acquiring module, adapted to acquire multiple groups of frames from a stream of frames;
a processing module, adapted to process each group of frames out of the multiple groups of frames to provide a video file; and
a video transmission interface, adapted to transmit the video files to the target system;
wherein the acquiring, processing and transmitting partially overlap.

15. The system according to claim 14, wherein each group of frames is characterized by a display rate; and wherein the video transmission interface is adapted to transmit the video files to the target system in response to a target rate that is substantially slower than the display rate.

16. The system according to claim 14, wherein the processing module is adapted to replace, following the processing of each group of frames, a previous video with the provided video file in a video files buffer; and wherein the video transmission interface is adapted to transmit video files from the video files buffer to the target system.

17. The system according to claim 16, wherein the processing module is further adapted to replace a previous video file that was not transmitted to the target system with the provided video file.

18. The system according to claim 14, wherein the frame acquiring module is further adapted to acquire display information.

19. The system according to claim 14, wherein the processing module is further adapted to analyze colors of at least one frame of a group of frames when processing the group of frames.

20. The system according to claim 14, further adapted to determine a video file to be transmitted, wherein the video transmission interface is adapted to selectively transmit video files to the target system in response to results of the determining.

21. The system according to claim 14, further adapted to receive, from an external system input that is influential for the generating of the stream of frames.

22. A computer readable medium having computer-readable code embodied therein for providing video content, the computer-readable code comprising instructions for:
acquiring multiple groups of frames from a stream of frames;
processing each group of frames out of the multiple groups of frames to provide a video file; and
transmitting the video files to the target system; wherein the stages of acquiring, processing and transmitting partially overlap.

23. The computer readable medium according to claim 22, wherein each group of frames is characterized by a display rate; and wherein the instructions for transmitting further comprise instructions for transmitting in response to a target rate that is substantially slower than the display rate.

24. The computer readable medium according to claim 22, wherein the computer-readable code further comprises instructions for replacing, following the processing of each group of frames, a previous video with the provided video file in a video files buffer; and wherein the instructions for transmitting further comprise instructions for transmitting video files from the video files buffer to the target system.

25. The computer readable medium according to claim 24, wherein the instructions for replacing further comprise instructions for replacing a previous video file that was not transmitted to the target system with the provided video file.

26. The computer readable medium according to claim 22, wherein the instructions for acquiring comprised in the computer-readable code further comprise instructions for acquiring display information.

27. The computer readable medium according to claim 22, wherein the instructions for processing further comprise instructions for analyzing, during the processing of at least one group of frames, colors of at least one frame of the group of frames.

28. The computer readable medium according to claim 22, wherein the computer-readable code further comprises instructions for grouping frames into multiple sequential groups of frames in response to timing information.

29. The computer readable medium according to claim 22, wherein the computer-readable code further comprises instructions for receiving, from an external system, input that is influential for the generating of the stream of frames.

30. The computer readable medium according to claim 22, wherein the computer-readable code further comprises instructions for generating the stream of frames.

31. The computer readable medium according to claim 22, wherein the computer-readable code further comprises instructions for determining a video file to be transmitted, and wherein the instructions for transmitting comprises instructions for selectively transmitting video files to the target system in response to results of the determining.
